(19) United States
(12) Patent Application Publication
(10) Pub. No.: US 2024/0220846 A1
(43) Pub. Date: Jul. 4, 2024

(54) EDGE COMPUTING ORCHESTRATION

(71) Applicant: Nokia Solutions and Networks Oy, Espoo (FI)

(72) Inventors: Sasu TARKOMA, Helsinki (FI); Kimmo Kalervo HÄTÖNEN, Espoo (FI)

(21) Appl. No.: 18/557,763

(22) PCT Filed: Apr. 30, 2021
(86) PCT No.: PCT/EP2021/061389

§ 371 Date: Oct. 27, 2023

(51) Int. Cl. G06N 10/80

(52) U.S. Cl. CPC G06N 10/80

(57) ABSTRACT

According to an example embodiment, an edge computing orchestration device is configured to obtain resource data indicating available edge computing resources, wherein the available edge computing resources comprises at least classical edge computing resources and quantum edge computing resources; obtain software to be executed using the edge computing resources, wherein the software comprises at least classical software and quantum software; identify classical tasks and quantum tasks in the software based on the at least classical software and quantum software; and assign the classical tasks and the quantum tasks to be executed on the available edge computing resources. Devices, methods and computer programs are disclosed.

### TECHNICAL FIELD

The present application generally relates to the field of edge computing. In particular, the present application relates to an edge computing orchestration device and related methods and computer programs.

### BACKGROUND

The first generation of quantum computers are expected to be in datacentres. However, this may result in similar drawbacks as with classical datacentres. For example, response times may be greater compared to local computing and large amounts of bandwidth may be required to the datacentre. Thus, it may be beneficial to utilise edge computing for quantum computers. However, the pro-visioning of applications and network services over edge computing scenarios introduces further technical chal-lenges. Further, quantum computing introduces new parameters and considerations, such as, the identification of quantum algorithms and parameters from classical code, quantum computer configuration cost, cost of in-terconnecting qubit resources, computing time, computing reliability, optimisations pertaining to reuse of quantum states, and error correction parameterisation SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of an edge computing orchestration device comprises at least one processor and at least one memory comprising computer program code. The at least one memory and the computer program code are configured to, with the at least one processor, cause the edge computing orchestration device to: obtain resource data indicating available edge computing resources, wherein the available edge computing resources comprises at least classical edge computing resources and quantum edge computing resources; obtain software to be executed using the edge computing resources, wherein the software comprises at least classical software and quantum software; identify classical tasks and quantum tasks in the software based on the at least classical software and quantum software; and assign the classical tasks and the quantum tasks to be executed on the available edge computing resources. The edge computing orchestration device can, for example, efficiently assign the classical and quantum tasks to be executed using appropriate resources.

An example embodiment of an edge computing orchestration device comprises means for performing: obtain resource data indicating available edge computing resources, wherein the available edge computing resources comprises at least classical edge computing resources and quantum edge computing resources; obtain software to be executed using the edge computing resources, wherein the software comprises at least classical software and quantum software; identify classical tasks and quantum tasks in the software based on the at least classical software and quantum software; and assign the classical tasks and the quantum tasks to be executed on the available edge computing resources.

In an example embodiment, alternatively or in addition to the above-described example embodiments, the at least one memory and the computer program code are further configured to, with the at least one processor, cause the edge computing orchestration device to: identify at least one classical task in the classical tasks that can be quantum offloaded, wherein the quantum offloading transforms a classical task into at least one quantum task; and perform quantum offloading on the at least one classical task. The edge computing orchestration device can, for example, assign a classical task to be executed using the quantum edge computing resources if this is more efficient than executing the task using classical edge computing resources.

In an example embodiment, alternatively or in addition to the above-described example embodiments, the at least one memory and the computer program code are further configured to, with the at least one processor, cause the edge computing orchestration device to: generate a directed acyclic graph, DAG, describing interdependencies between the classical tasks and the quantum tasks; and assign the classical tasks and quantum tasks to be executed on the available edge computing resource according to the DAG. The edge computing orchestration device can, for example, efficiently take into account the interdependencies between the tasks so that the tasks can be assigned for execution in an appropriate manner.

In an example embodiment, alternatively or in addition to the above-described example embodiments, the assigning the classical tasks and the quantum tasks to be executed on the available edge computing resource comprises: distributing the classical tasks to the classical edge computing resources and distributing the quantum tasks to the quantum edge computing resources; and/or scheduling execution of the classical tasks using the classical edge computing resources and scheduling execution of the quantum tasks using the quantum edge computing resources. The edge computing orchestration device can, for example, efficiently distribute and/or schedule the classical and quantum tasks to be executed using appropriate resources.

In an example embodiment, alternatively or in addition to the above-described example embodiments, the at least one memory and the computer program code are further configured to, with the at least one processor, cause the edge computing orchestration device to: virtualise the available edge computing resources, producing virtualised edge computing resources; and assign the classical tasks and the quantum tasks to be executed on the virtualised edge computing resources. The edge computing orchestration device can, for example, efficiently assign the classical and quantum tasks to be executed using appropriate resources by virtualising the available edge computing resources.

In an example embodiment, alternatively or in addition to the above-described example embodiments, the classical edge computing resources comprises at least one of: central processing units, graphical processing units, or tensor processing units. The edge computing orchestration device can, for example, utilise different kinds of classical resources for the execution of the tasks.

In an example embodiment, alternatively or in addition to the above-described example embodiments, the classical edge computing resources are configured to communicate via at least one classical network and the quantum edge computing resources are configured to communicate via at least one classical network and/or at least one quantum network. The edge computing resources 10 can, for example, communicate efficiently.

In an example embodiment, alternatively or in addition to the above-described example embodiments, the at least one memory and the computer program code are further configured to, with the at least one processor, cause the edge computing orchestration device to configure the at least one classical network and/or the at least one quantum network to implement the execution of the classical tasks and of the quantum tasks.

The edge computing orchestration device can, for example, utilise the classical networks and/or the quantum networks for the execution of the tasks.

An example embodiment of an edge computing system comprises the edge computing orchestration device according to any preceding claim and a plurality of edge computing resources, wherein the plurality of edge computing resources comprises at least classical edge computing resources and quantum edge computing resources. The edge computing system can, for example, efficiently utilise the classical and quantum edge computing resources for the execution of the tasks.

In an example embodiment, alternatively or in addition to the above-described example embodiments, the edge computing system further comprises a publish-subscribe module configured to provide publish-subscribe mechanism to the classical edge computing resource and/or to the quantum edge computing resources. The edge computing system can, for example, provide an efficient way for controlling the classical and quantum edge computing resource via the publish-subscribe mechanism.

An example embodiment of a method comprises: obtaining resource data indicating available edge computing resources, wherein the available edge computing resources comprises at least classical edge computing resources and quantum edge computing resources; obtaining software to be executed using the edge computing resources, wherein the software comprises at least classical software and quantum software; identifying classical tasks and quantum tasks in the software based on the at least classical software and quantum software; and assigning the classical tasks and the quantum tasks to be executed on the available edge computing resources. The method can, for example, efficiently assign the classical and quantum tasks to be executed using appropriate resources.

In an example embodiment, alternatively or in addition to the above-described example embodiments, the method further comprises: identifying at least one classical task in the classical tasks that can be quantum offloaded, wherein the quantum offloading transforms a classical task into at least one quantum task; and performing quantum offloading on the at least one classical task. The method can, for example, assign a classical task to be executed using the quantum edge computing resources if this is more efficient than executing the task using classical edge computing resources.

In an example embodiment, alternatively or in addition to the above-described example embodiments, the method further comprises: generating a directed acyclic graph, DAG, describing interdependencies between the classical tasks and the quantum tasks; and assigning the classical tasks and quantum tasks to be executed on the available edge computing resource according to the DAG. The method can, for example, efficiently take into account the interdependencies between the tasks so that the tasks can be assigned for execution in an appropriate manner.

In an example embodiment, alternatively or in addition to the above-described example embodiments, the assigning the classical tasks and the quantum tasks to be executed on the available edge computing resource comprises: distributing the classical tasks to the classical edge computing resources and distributing the quantum tasks to the quantum edge computing resources; and/or scheduling execution of the classical tasks using the classical edge computing resources and scheduling execution of the quantum tasks using the quantum edge computing resources. The method can, for example, efficiently distribute and/or schedule the classical and quantum tasks to be executed using appropriate resources.

In an example embodiment, alternatively or in addition to the above-described example embodiments, the method further comprises: virtualising the available edge computing resources, producing virtualised edge computing resources; and assigning the classical tasks and the quantum tasks to be executed on the virtualised edge computing resources. The method can, for example, efficiently assign the classical and quantum tasks to be executed using appropriate resources by virtualising the available edge computing resources.

In an example embodiment, alternatively or in addition to the above-described example embodiments, the classical edge computing resources comprises at least one of: central processing units, graphical processing units, or tensor processing units. The method can, for example, utilise different kinds of classical resources for the execution of the tasks.

In an example embodiment, alternatively or in addition to the above-described example embodiments, the classical edge computing resources are configured to communicate via at least one classical network and the quantum edge computing resources are configured to communicate via at least one classical network and/or at least one quantum network. The computing resources can, for example, communicate efficiently.

In an example embodiment, alternatively or in addition to the above-described example embodiments, the method further comprises configuring the at least one classical network and/or the at least one quantum network to implement the execution of the classical tasks and of the quantum tasks. The method can, for example, utilise the classical networks and/or the quantum networks for the execution of the tasks.

An example embodiment of a computer program product comprises program code configured to perform the method according to any of the above example embodiments, when the computer program product is executed on a computer.

### DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 shows an example embodiment of the subject matter described herein illustrating an edge computing orchestration device;

FIG. 2 shows an example embodiment of the subject matter described herein illustrating an edge computing system;

FIG. 3 shows an example embodiment of the subject matter described herein illustrating an overview of a system architecture for edge computing;

FIG. 4 shows an example embodiment of the subject matter described herein illustrating a system model for edge computing orchestration;

FIG. 5 shows an example embodiment of the subject matter described herein illustrating a directed acyclic graph of classical tasks and quantum tasks;

FIG. 6 shows an example embodiment of the subject matter described herein illustrating mapping of tasks to edge computing resources;

FIG. 7 shows an example embodiment of the subject matter described herein illustrating an edge creation process;

FIG. 8 shows an example embodiment of the subject matter described herein illustrating application partitioning and deployment over edge resources in a hybrid mode;

FIG. 9 shows an example embodiment of the subject matter described herein illustrating a publish-subscribe mechanism; and

FIG. 10 shows an example embodiment of the subject matter described herein illustrating a method.

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different example embodiments.

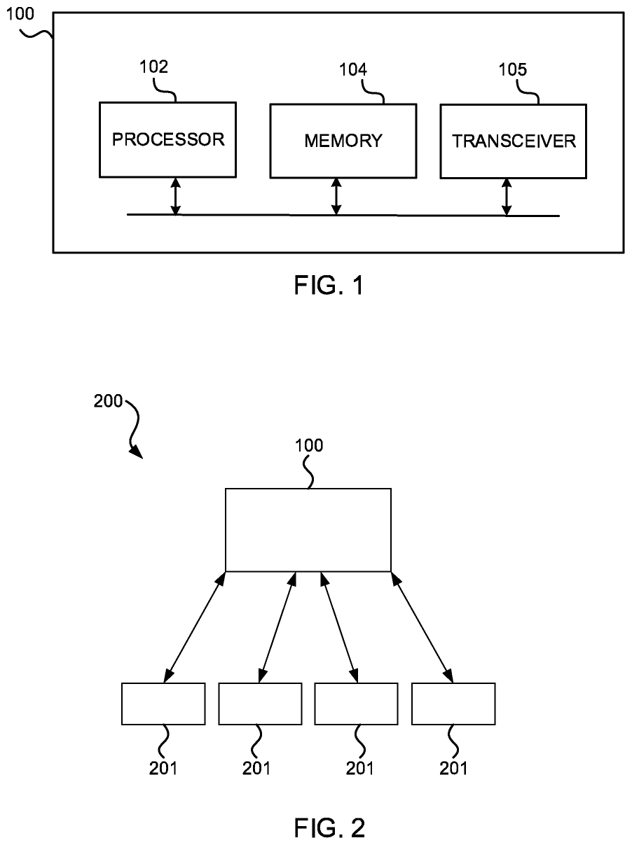

FIG. 1 is a block diagram of an edge computing orchestration device 100 in accordance with an example embodiment.

According to an example embodiment, the edge computing orchestration device 100 comprises one or more processors 102, and one or more memories 104 that comprise computer program code. The edge computing orchestration device 100 may also comprise a transceiver 105, as well as other elements, such as an input/output module (not shown in FIG. 1), and/or a communication interface (not shown in FIG. 1).

Herein, the edge computing orchestration device 100 may also be referred to as an orchestrator.

According to an example embodiment, the at least one memory 104 and the computer program code are configured to, with the at least one processor 102, cause the edge computing orchestration device 100 to obtain resource data indicating available edge computing resources, wherein the available edge computing resources comprises at least classical edge computing resources and quantum edge computing resources.

The classical edge computing resources may be referred to as classical edges. The quantum edge computing resources may be referred to as quantum edges.

The classical edge computing resources may comprise, for example, at least one of: central processing units, graphical processing units, or tensor processing units.

The edge computing orchestration device 100 may be further configured to obtain software to be executed using the edge computing resources, wherein the software comprises at least classical software and quantum software.

The software to be executed may also be referred to as input software, software, or similar.

The edge computing orchestration device 100 may be further configured to identify classical tasks and quantum tasks in the software based on the at least classical software and quantum software.

Herein, a “task” may comprise any part of a software to be executed. For example, a task may corre-spond to an algorithm, a subroutine, or a function of the software.

Identifying classical tasks and quantum tasks in the software based on the at least classical software and quantum software may comprise identifying different classical tasks in the classical software and/or identifying different quantum tasks in the quantum software. Further, identifying classical tasks and quantum tasks in the software may further comprise, for example, identifying parts of the classical software that have bounded-error quantum polynomial time (BQP) computa-tional complexity. Such tasks could be executed faster using the quantum edge computing resources. Thus, the edge computing orchestration device 100 may convert such classical tasks into quantum tasks.

The edge computing orchestration device 100 may be further configured to assign the classical tasks and the quantum tasks to be executed on the available edge computing resources.

The edge computing orchestration device 100 may be configured to, for example, assign the classical tasks to be executed using the classical edge computing resources and assign the quantum tasks to be executed using the quantum edge computing resources. The assigning may comprise, for example, distributing the different tasks to different edge computing resources and/or scheduling the execution of the tasks.

Although the edge computing orchestration device 100 may be depicted to comprise only one processor 102, the edge computing orchestration device 100 may comprise more processors. In an example embodiment, the memory 104 is capable of storing instructions, such as an operating system and/or various applications.

Furthermore, the processor 102 is capable of executing the stored instructions. In an example embodiment, the processor 102 may be embodied as a multi-core processor, a single core processor, or a combination of one or more multi-core processors and one or more single core processors. For example, the processor 102 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accel-erator, a special-purpose computer chip, or the like. In an example embodiment, the processor 102 may be configured to execute hard-coded functionality. In an example embodiment, the processor 102 is embodied as an executor of software instructions, wherein the instructions may specifically configure the processor 102 to perform the algorithms and/or operations described herein when the instructions are executed.

The memory 104 may be embodied as one or more volatile memory devices, one or more non-volatile memory devices, and/or a combination of one or more volatile memory devices and non-volatile memory devices. For example, the memory 104 may be embodied as semiconductor memories (such as mask ROM, PROM (programmable ROM), EPROM (erasable PROM), flash ROM, RAM (random access memory), etc.).

Some terminology used herein may follow the naming scheme of 4G or 5G technology in its current form. However, this terminology should not be considered limiting, and the terminology may change over time. Thus, the following discussion regarding any example embodiment may also apply to other technologies, such as 6G.

At least some example embodiments disclosed herein can enable performance improvements by offloading application software to quantum processing units (QPUs). Any application functionality that can be compiled offline or online for the QPU can gain this benefit.

In some example embodiments, a QPU can be a Noisy Intermediate-Scale Quantum (NISQ) device.

FIG. 2 shows an example embodiment of the subject matter described herein illustrating an edge computing system.

According to an example embodiment, an edge computing system 200 comprises the edge computing orchestration device 100 and a plurality of edge computing resources 201. The plurality of edge computing resources 201 may comprise at least classical edge computing resources and quantum edge computing resources.

Each edge computing resource 201 in the plurality of edge computing resource may comprise classical edge computing resources and/or quantum edge computing resources.

The plurality of edge computing resources 201 may be configured to perform edge computing as orches-trated by the edge computing orchestration device 100.

An edge computing resource 201 may also be referred to as an edge. A classical edge computing resource may also be referred to as a classical edge. A quantum edge computing resource may also be referred to as a quantum edge.

The edge computing system 200 may comprise various other devices/components/units/modules not illustrated in the example embodiment of FIG. 2.

The edge computing system 200 may be utilised in, for example, artificial intelligence algorithms (including neural networks) and optimizations problems. The quantum edge computing resources can, for example, op-timize network-related, computationally difficult problems.

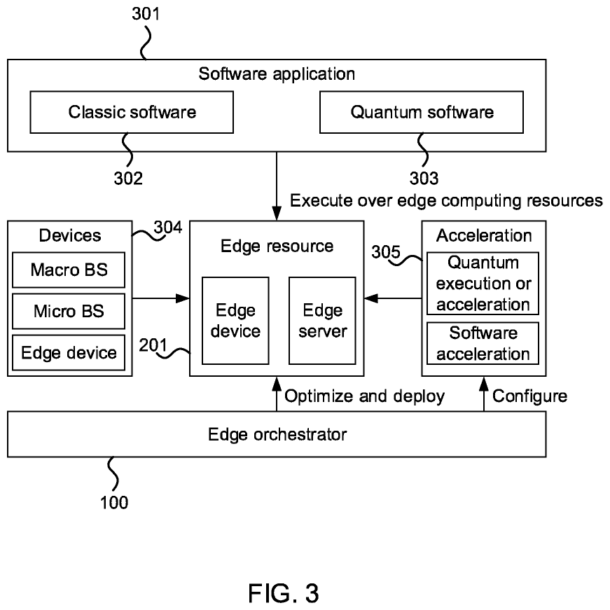

FIG. 3 shows an example embodiment of the subject matter described herein illustrating an overview of a system architecture for edge computation.

The software 301 can comprise at least two parts: a classical software 302 and a quantum software 303. The classical software 302 can be executed/offloaded with, for example, central processing units (CPUs), graphics processing units (GPUs), and/or tensor processing units (TPUs). The quantum part 303 can be compiled offline or online for quantum processing units (QPUs).

The software 301 may be provided as a mix of software of different categories. For example, the input software may comprise classical software, classical software with quantum application programming interface (API) calls to established (pre-installed) quantum components and services, and/or quantum software with quantum algorithms that can be executed directly over quantum resources.

The edge computing orchestration device 100 can resolve the part (classical, classical+ quantum API, quantum) and possible transformations from classical to quantum.

The quantum edge orchestrator can operate in, for example, two modes. In a first mode, referred to as a basic mode, the quantum edge orchestration device 100 can deploy the application 301 to the selected edge resource while taking advantage of the CPUs, GPUS, TPUS, and QPUs. In a second mode, referred to as an advanced mode, the quantum edge orchestration device 100 can cre-ate a quantum edge computing environment by virtualising the QPUs, TPUs, GPUs, and CPUs for the quantum and classical parts of the application 301 across the edge computing resources and classical and quantum networks.

According to an example embodiment, the edge computing orchestration device 100 is further configured to virtualise the available edge computing resources, producing virtualised edge computing resources and assign the classical tasks and the quantum tasks to be executed on the virtualised edge computing resources.

The edge computing orchestration device 100 can take into account the input software and map it to both classical and quantum resources while orchestrating the execution of the software processes over the edge computing resources.

According to an example embodiment, the edge computing orchestration device 100 is further configured to identify at least one classical task in the classical tasks that can be quantum offloaded, wherein the quantum offloading transforms a classical task into at least one quantum task, and perform quantum offloading on the at least one classical task. The classical task may be transformed into one or more quantum and/or classical tasks.

The edge computing orchestration device 100 can identify classical algorithms/tasks and transform them into quantum algorithms/tasks through quantum offloading. Thus, the edge computing orchestration device 100 can be automated to a certain extent in terms of its capability to map classical software to quantum software. In addition, the combination of quantum resources over distinct geographical regions via quantum networks has been demonstrated. Thus, the edge computing orchestration device 100 can manage the execution of software over the heterogeneous classical and quantum resources.

In an example embodiment, the edge computing orchestration device 100 can accept hybrid classical-quantum programs and extract tasks and algorithms from the software for execution over the classical and quantum edge computing resources.

The edge computing orchestration device 100 can be configured to perform quantum offloading (identification, generation, and parameterisation of quantum algorithms based on classical code) into account while being able to optimise the use of resources in terms of software and task analysis, resource utilisation analysis (qubits, shared state, configuration cost etc) and/or do this mapping at runtime.

An edge computing resource 201 may comprise an edge device and/or an edge server.

The edge computing orchestration device 100 may be configured to optimise and deploy the software 301 to be execute over edge computing resources 201.

The edge computing system may comprise various devices 304 depending on the application of the edge computing system. For example, the system may comprise macro base stations, micro base stations, and/or edge devices. These devices may utilise the computing performed by the edge computing system.

The edge computing system may perform acceleration 305. Acceleration may comprise, for example, quantum execution or acceleration and/or software acceleration. The acceleration can be configured by, for example, the edge computing orchestration device 100.

Different components of the edge computing system may communicate via a classical-quantum data bus.

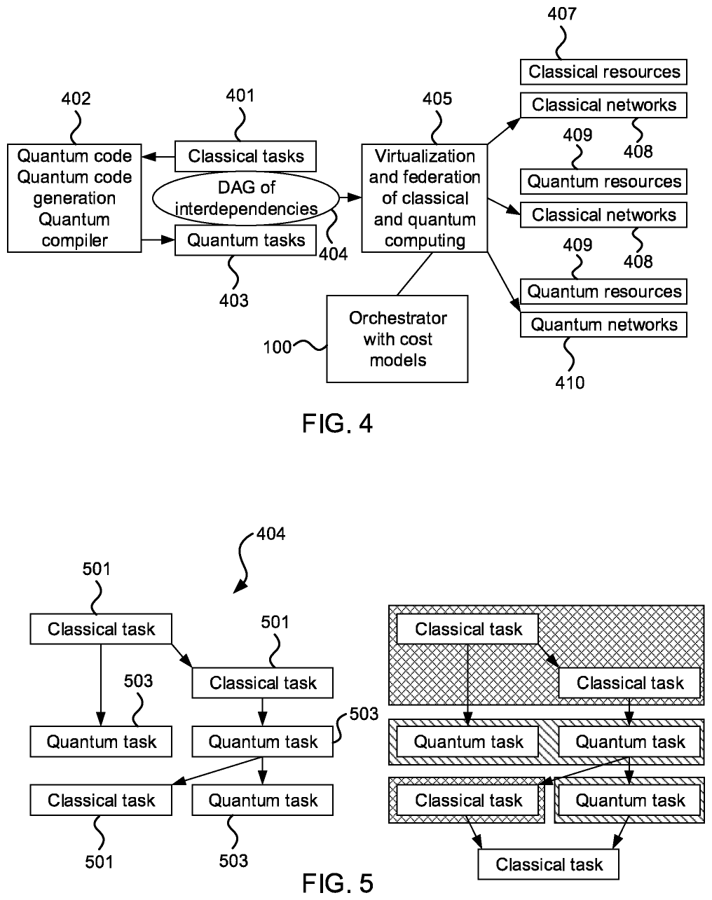

FIG. 4 shows an example embodiment of the subject matter described herein illustrating a system model for edge computing orchestration.

In operation 401, classical tasks can be determined. In operation 402, quantum code can be generated and compiled. In operation 403, quantum tasks can be determined. Thus, operations 401-403 can determine the software code for the classical and quantum tasks. The edge computing orchestration device 100 may be configured to generate an execution plan for the software to be executed. Different requirements, such as processing, memory etc, and costs can be taken into account when creating the plan. This can involve both tracking and adjustment actions. The plan can be pro-duced using, for example, optimisation methods.

According to an example embodiment, the assigning the classical tasks and the quantum tasks to be executed on the available edge computing resource comprises: distributing the classical tasks to the classical edge computing resources and distributing the quantum tasks to the quantum edge computing resources and/or scheduling execution of the classical tasks using the classical edge computing resources and scheduling execution of the quantum tasks using the quantum edge computing resources.

When quantum edge computing resource is ad-justed to requirements, parts of the program to be run can be scheduled. Scheduling can take into account the conditions of the resources and capabilities. Specific features can be connecting QPU units by quantum network and re-using the quantum states and parameterization of debugging.

The execution plan may comprise, for example, a directed acyclic graph (DAG). Based on the classical 401 and quantum 403 tasks, a DAG 404 of interdependencies between the classical 401 and quantum tasks 403 can be generated.

In some example embodiments, the interdependencies can be represented in some other manner than a DAG.

In operation 405, the orchestrator 100 can lev-erage the virtualized classical and quantum resources and schedule the tasks over the virtual resources taking cost model into account.

The computations can be performed in parallel on classical 407 and quantum computing resources 409. The overall application behaviour is rendered by the tasks. The tasks can be expected to utilize both classical 408 and quantum 410 communication buses/information storage that eventually results in a classical result or a progression of results when running tasks iteratively.

FIG. 5 shows an example embodiment of the subject matter described herein illustrating a directed acyclic graph of classical tasks and quantum tasks. The scheduler can take dependencies between tasks and time budgets into account and map the classical and quantum tasks to virtualized resources. The virtualised resources can comprise physical classical resources (CPUs, GPUS, TPUs), classical storage, quantum resources (QPUs), and quantum storage. The classical resources can be connected via classical networks and quantum resources can be connected via classical or quantum networks.

FIG. 5 illustrates an example embodiment DAG-based scheduling. The scheduler can optimise the mapping of the classical 501 and quantum 503 tasks to classical and quantum resources based on the DAG 404. The scheduler may be implemented via classical and/or quantum components.

According to an example embodiment, the edge computing orchestration device 100 is further configured to generate a DAG 404 describing interdependencies between the classical tasks and the quantum tasks and assign the classical tasks and quantum tasks to be executed on the available edge computing resource according to the DAG.

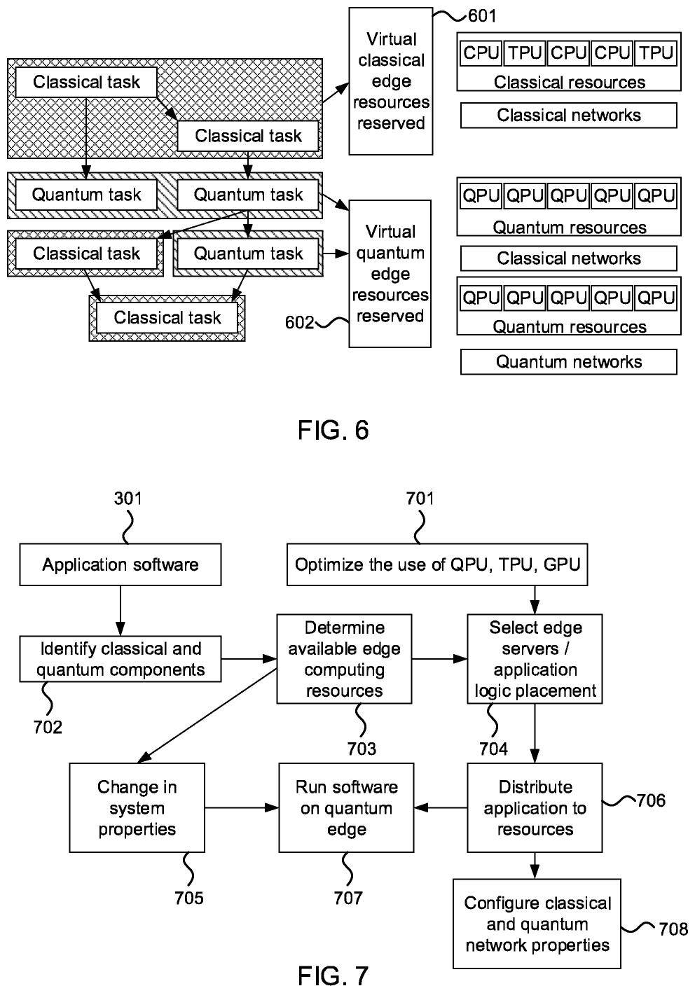

FIG. 6 shows an example embodiment of the subject matter described herein illustrating mapping of tasks to edge computing resources.

The classical tasks 501 can be mapped to reserved virtual classical edge computing resources 601. The reserved virtual classical edge computing resources 601 can be static or dynamic.

The quantum tasks 503 can be mapped to reserved virtual quantum edge computing resources 602. The reserved virtual quantum edge computing resources 602 can be static or dynamic.

FIG. 7 shows an example embodiment of the subject matter described herein illustrating an edge creation process.

In operation 702, classical and quantum components of the software 301 can be identified. Thus, application requirements regarding both classical and quantum resources can be identified. This can be done manually or automatically.

In operation 703, the available edge computing resources can be determined. For example, the edge creation component can then determine the resources that are available. The available resource may comprise, for example, edge computing resources that are available within a region.

In operation 701, the use of the different resource types can be optimised.

In operation 704, the resources can be selected and reserved. The reservation may be performed through, for example, a classical resource reservation protocol and may involve selecting the edge servers and quantum computers connected by classical networks and possibly quantum networks. Scheduling and placement can take into account the configuration and communication cost (multi-dimensional cost factors).

The edge creation component can setup the necessary subscriptions (event triggers) to be able to monitor the virtual quantum edge consisting of classical-quantum resources.

After resource reservation, the edge creation can instantiate the necessary components over the resources and monitor their operation through, for example, event triggers.

In operation 705, system properties can be changed, if required.

In operation 706, the application software can be distributed to the hardware resources.

In operation 708, classical and quantum network properties can be configured. This may comprise, for example, configuring quantum network properties for in-terconnecting the QPUs.

In operation 707 the software can be run on the quantum edge. Classical and quantum parts can be executed over respective resources and using configured networks.

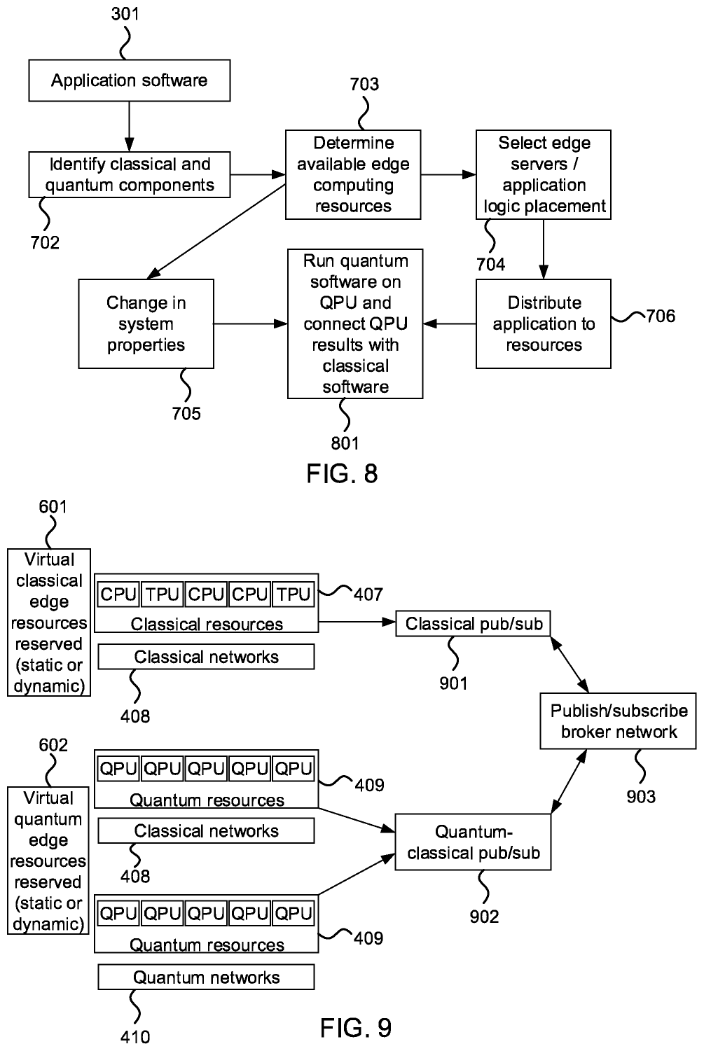

FIG. 8 shows an example embodiment of the subject matter described herein illustrating application partitioning and deployment over edge resources in a hybrid mode.

The example embodiment of FIG. 8 discloses a procedure when a quantum edge needs to be reconfigured due to changes in the requirements or resources. The procedure may be similar to that presented in the example embodiment of FIG. 7. In operation 801, the quantum software can be run on quantum edge computing resources, such as QPUs, and the results can be connected with classical software.

FIG. 9 shows an example embodiment of the subject matter described herein illustrating a publish-subscribe mechanism.

According to an example embodiment, the edge computing system further comprises a publish-subscribe module configured to provide publish-subscribe mechanism to the classical edge computing resource and/or to the quantum edge computing resources.

According to an example embodiment, the classical edge computing resources are configured to communicate via at least one classical network and the quantum edge computing resources are configured to communicate via at least one classical network and/or at least one quantum network.

According to an example embodiment, the edge computing orchestration device is further configured to configure the at least one classical network and/or the at least one quantum network to implement the execution of the classical tasks and of the quantum tasks. The quantum and the classical networks may be configured to jointly implement the execution of the tasks.

In some example embodiments, the publish-subscribe module may be configured to provide a classical publish-subscribe mechanism 901 to the classical edge computing resource and/or a quantum publish-subscribe mechanism 902 to the quantum edge computing resource. The publish-subscribe mechanisms 901, 902 may be provided via a publish-subscribe broker network 903.

A publish-subscribe mechanism can allow classical software components to subscribe to events related to quantum resources and processes and allow quantum software components to receive updates from classical software components.

The publish-subscribe mechanism can utilise low-level data access primitives of quantum resources and a mechanism for querying a property of a quantum resource (read API) and detecting observable changes related to the process (notify API) are supported by the hardware. The publish-subscribe mechanism can also utilise a mechanism to write state updates related to quantum resources (write API). Based on these primitives, the edge computing system can mediate asynchronous event-based information between the classical and quantum realms and realizes a quantum publish/subscribe protocol.

The edge computing orchestration device 100 can monitor operating parameters of the classical and quantum edge computing resources during execution of the classical and quantum tasks. The edge computing orchestration device 100 may also be configured to perform quantum network management.

The edge computing orchestration device 100 may be further configured to control the classical edge computing resources and/or the quantum edge computing resources using the publish-subscribe mechanism. The edge computing orchestration device 100 may be configured to, for example, control the instrumentation of the quantum edge computing resources using the publish-subscribe mechanism.

The parameterisation of the quantum edge computing resources and of the quantum networks may be performed via dedicated quantum controller components that may have a classical API for obtaining telemetry and configuring the quantum edge computing resources. In a similar manner to Software-defined Networking (SDN) for the classical case, the quantum resources may be interconnected via Quantum SDN.

The edge computing orchestration device 100 can monitor the implementation of the execution plan and react monitoring publish-subscribe in the edge computing system components. On quantum side the diagnostics can be monitored to be able to notice the possible problems and to react to them.

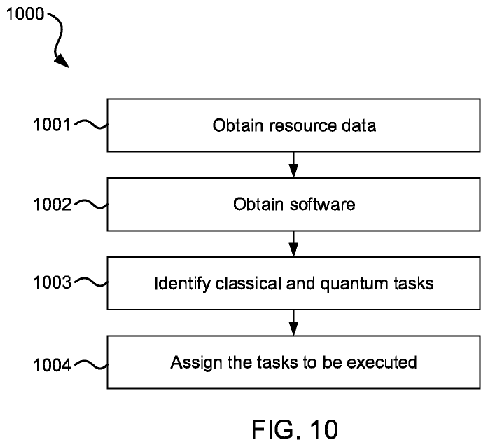

FIG. 10 shows an example embodiment of the subject matter described herein illustrating a method 1000. According to an example embodiment, the method 1000 comprises obtaining 1001 resource data indicating available edge computing resources, wherein the available edge computing resources comprises at least classical edge computing resources and quantum edge computing resources.

The method 1000 may further comprise obtaining 1002 software to be executed using the edge computing resources, wherein the software comprises at least classical software and quantum software.

The method 1000 may further comprise identifying 1003 classical tasks and quantum tasks in the software based on the at least classical software and quantum software.

The method 1000 may further comprise assigning 1004 the classical tasks and the quantum tasks to be executed on the available edge computing resources.

It is to be understood that the order in which operations 1001-1004 are performed, may vary from the example embodiments depicted in FIG. 10.

The method 1000 may be performed by the edge computing orchestration device 100 of FIG. 1. Further features of the method 1000 directly result from the functionalities and parameters of the edge computing orchestration device 100. The method 100 can be performed, at least partially, by computer program (s).

An apparatus may comprise means for performing any aspect of the method (s) described herein. According to an example embodiment, the means comprises at least one processor, and memory comprising program code, the at least one processor, and program code configured to, when executed by the at least one processor, cause performance of any aspect of the method.

Herein, when referring to any data processing means, such as processors and memory, program code, or computer program products, this may comprise classical and/or quantum processing means, program code, and/or computer program products.

The functionality described herein can be performed, at least in part, by one or more computer program product components such as software components. According to an example embodiment, the edge computing orchestration device 100 comprises a processor configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Stand-ard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also any example embodiment may be combined with another example embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclu-sive list and a method or apparatus may contain addi-tional blocks or elements.

It will be understood that the above description is given by way of example only and that various modifications may be made by those skilled in the art. The above specification, examples and data provide a complete description of the structure and use of exem-plary embodiments. Although various example embodiments have been described above with a certain degree of par-ticularity, or with reference to one or more individual example embodiments, those skilled in the art could make numerous alterations to the disclosed example embodiments without departing from the spirit or scope of this specification.

1. An edge computing orchestration device, comprising:
at least one processor; and
at least one memory including computer program code;
the at least one memory and the computer program code configured to, when executed by the at least one processor, cause the edge computing orchestration device to:
obtain resource data indicating available edge computing resources, wherein the available edge computing resources comprises at least classical edge computing resources and quantum edge computing resources;
obtain software to be executed using the edge computing resources, wherein the software comprises at least classical software and quantum software;
identify classical tasks and quantum tasks in the software based on the at least classical software and quantum software; and
assign the classical tasks and the quantum tasks to be executed on the available edge computing resources.

2. The edge computing orchestration device according to claim 1, wherein the at least one memory and the computer program code are further configured to, when executed by the at least one processor, cause the edge computing orchestration device to:
identify at least one classical task in the classical tasks that can be quantum offloaded, wherein the quantum offloading transforms a classical task into at least one quantum task; and
perform quantum offloading on the at least one classical task.

3. The edge computing orchestration device according to claim 1, wherein the at least one memory and the computer program code are further configured to, when executed by the at least one processor, cause the edge computing orchestration device to:
generate a directed acyclic graph describing interdependencies between the classical tasks and the quantum tasks; and
assign the classical tasks and quantum tasks to be executed on the available edge computing resource according to the DAG.

4. The edge computing orchestration device according to claim 1, wherein the assigning the classical tasks and the quantum tasks to be executed on the available edge computing resource comprises:
distributing the classical tasks to the classical edge computing resources and distributing the quantum tasks to the quantum edge computing resources; and/or
scheduling execution of the classical tasks using the classical edge computing resources and scheduling execution of the quantum tasks using the quantum edge computing resources.

5. The edge computing orchestration device according to claim 1, wherein the at least one memory and the computer program code are further configured to, when executed by the at least one processor, cause the edge computing orchestration device to:
virtualise the available edge computing resources, producing virtualised edge computing resources; and
assign the classical tasks and the quantum tasks to be executed on the virtualised edge computing resources.

6. The edge computing orchestration device according to claim 1, wherein the classical edge computing resources comprise at least one of the following: central processing units, graphical processing units, or tensor processing units.

7. The edge computing orchestration device according to claim 1, wherein the classical edge computing resources are communicated with via at least one classical network and the quantum edge computing resources are communicated with via at least one of the following: the at least one classical network at least one quantum network.

8. The edge computing orchestration device according to claim 7, wherein the at least one memory and the computer program code are further configured to, when executed by the at least one processor, cause the edge computing orchestration device to configure at least one of the at least one classical network the at least one quantum network to respectively implement execution of the classical tasks and of the quantum tasks.

9. (canceled)

10. (canceled)

11. A method comprising:
obtaining resource data indicating available edge computing resources, wherein the available edge computing resources comprises at least classical edge computing resources and quantum edge computing resources;
obtaining software to be executed using the edge computing resources, wherein the software comprises at least classical software and quantum software;
identifying classical tasks and quantum tasks in the software based on the at least classical software and quantum software; and
assigning the classical tasks and the quantum tasks to be executed on the available edge computing resources.

12. The method according to claim 11, further comprising:
identifying at least one classical task in the classical tasks that can be quantum offloaded, wherein the quantum offloading transforms a classical task into a quantum task; and
performing quantum offloading on the at least one classical task.

13. The method according to claim 12, further comprising:
generating a directed acyclic graph describing interdependencies between the classical tasks and the quantum tasks; and
assigning the classical tasks and quantum tasks to be executed on the available edge computing resource according to the DAG.

14. The method according to claim 11, wherein the assigning the classical tasks and the quantum tasks to be executed on the available edge computing resource comprises:
distributing the classical tasks to the classical edge computing resources and distributing the quantum tasks to the quantum edge computing resources; and/or
scheduling execution of the classical tasks using the classical edge computing resources and scheduling execution of the quantum tasks using the quantum edge computing resources.

15. A computer program product comprising at least one memory storing program code for a edge computing orchestration device that, when executed by at least one processor, cause the processor to:
obtain resource data indicating available edge computing resources, wherein the available edge computing resources comprises at least classical edge computing resources and quantum edge computing resources;
obtain software to be executed using the edge computing resources, wherein the software comprises at least classical software and quantum software;
identify classical tasks and quantum tasks in the software based on the at least classical software and quantum software; and
assign the classical tasks and the quantum tasks to be executed on the available edge computing resources.

16. The computer program product according to claim 15, wherein the computer program code is further configured to, when executed by the at least one processor, cause the at least one processor to:
identify at least one classical task in the classical tasks that can be quantum offloaded, wherein the quantum offloading transforms a classical task into at least one quantum task; and
perform quantum offloading on the at least one classical task.

17. The computer program product according to claim 15, wherein the computer program code is further configured to, when executed by the at least one processor, cause the at least one processor to:
generate a directed acyclic graph describing interdependencies between the classical tasks and the quantum tasks; and
assign the classical tasks and quantum tasks to be executed on the available edge computing resource according to the DAG.

18. The computer program product according to claim 15, wherein the assigning the classical tasks and the quantum tasks to be executed on the available edge computing resource comprises:
distributing the classical tasks to the classical edge computing resources and distributing the quantum tasks to the quantum edge computing resources; and/or
scheduling execution of the classical tasks using the classical edge computing resources and scheduling execution of the quantum tasks using the quantum edge computing resources.

19. The computer program product according to claim 15, wherein the computer program code is further configured to, when executed by the at least one processor, cause the at least one processor to:
virtualise the available edge computing resources, producing virtualised edge computing resources; and
assign the classical tasks and the quantum tasks to be executed on the virtualised edge computing resources.

20. The computer program product according to claim 15, wherein the classical edge computing resources comprise at least one of the following: central processing units, graphical processing units, or tensor processing units.

21. The computer program product according to claim 15, wherein the classical edge computing resources are communicated with via at least one classical network and the quantum edge computing resources are communicated with via at least one of the following: the at least one classical network or at least one quantum network.

22. The computer program product according to claim 21, wherein the at least one memory and the computer program code are further configured to, with the at least one processor, cause the at least one processor to configure at least one of the at least one classical network or the at least one quantum network to respectively implement execution of the classical tasks and of the quantum tasks.
